(19) United States
(12) Patent Application Publication
(10) Pub. No.: US 2012/0026480 A1
(43) Pub. Date: Feb. 2, 2012

(54) Image-Compensating Addressable Electrostatic Chuck System

(75) Inventors: Erik Roelof LOOPSTRA, Eindhoven (NL); Hendrik Antony Johannes Neerhof, Eindhoven (NL)

(73) Assignee: ASML Netherlands B.V., Veldhoven (NL)

(21) Appl. No.: 13/178,377

(22) Filed: Jul. 7, 2011

Related U.S. Application Data
(60) Provisional application No. 61/367,595, filed on Jul. 26, 2010.

(51) Int. Cl. G03B 27/54; H02N 13/00

(52) U.S. Cl. 355/67; 361/234; 355/77

(57) ABSTRACT

An electrostatic chuck including a substrate, a support layer to support an object, an electrode layer comprising an electrode and being disposed between the substrate and the support layer configured to apply an electrostatic attraction force on the object upon energization of the electrode, and a plurality of actuators for deforming the support layer.

### CROSS REFERENCE TO RELATED APPLICATIONS

This applications claims benefit under 35 U.S.C. 119(e) to U.S. Provisional patent Application No. 61/367,595, filed, Jul. 26, 2010, which is incorporated by reference herein in its entirety.

### BACKGROUND

1. Field of the Invention

The present invention generally relates to lithography, and more particularly to an electrostatic chuck system configured to clamp an object (e.g., a patterning device such as a mask, or a substrate) to a support.

2. Background Art

Lithography is widely recognized as a key process in manufacturing integrated circuits (ICs) as well as other devices and/or structures. A lithographic apparatus is a machine, used during lithography, which applies a desired pattern onto a substrate, such as onto a target portion of the substrate. During manufacture of ICs with a lithographic apparatus, a patterning device (which is alternatively referred to as a mask or a reticle) generates a circuit pattern to be formed on an individual layer in an IC. This pattern may be transferred onto the target portion (e.g., comprising part of, one, or several dies) on the substrate (e.g., a silicon wafer). Transfer of the pattern is typically via imaging onto a layer of radiation-sensitive material (e.g., resist) provided on the substrate. In general, a single substrate contains a network of adjacent target portions that are successively patterned. Manufacturing different layers of the IC often requires imaging different patterns on different layers with different reticles. Therefore, reticles must be changed during a lithographic process.

In order to ensure good imaging quality the patterning device and substrate must be firmly held in place by a chuck. The chuck can be manufactured with errors or irregularities that cause the chuck to be non-planar or have some other geometric deformation. Likewise, both the patterning device and/or the substrate can suffer from similar manufacturing errors that that cause them to be non-planar. With regard to the patterning device and substrate, such deformations can occur during operation of the lithographic system due to variables, such as heat absorption. The patterning device imparts to a beam of radiation a pattern, which is then imaged onto a substrate. Image quality of this projected radiation beam can be affected by image errors, such as image curvature, focus, distortion, and astigmatism.

The chuck can be formed with a series of vacuum points that hold onto the patterning device and/or substrate. However, extreme ultraviolet (EUV) lithography requires a vacuum environment. Therefore, a common practice in EUV systems is to use an electrostatic chuck to hold the patterning device and/or substrate.

The market demands that the lithographic apparatus perform the lithography process as efficiently as possible to maximize manufacturing capacity and keep costs per device low. This means keeping manufacturing defects to a minimum, which is why the effect of the non-planar deformations in the chuck, patterning device, and substrate, as well as imaging errors due to field curvature, focus, distortion, astigmatism, and scanning errors need to be minimized as much as practical.

### SUMMARY

Given the foregoing, what is needed is an electrostatic chuck system and method that minimizes effects of manufacturing and operational deformations in a chuck, patterning device, and/or substrate. To meet this need, embodiments of the present invention are directed to an image-compensating addressable electrostatic chuck system and method.

According to an embodiment of the present invention, there is provided an electrostatic chuck, comprising: a substrate, a support layer to support an object, an electrode layer comprising an electrode and being disposed between the substrate and the support layer configured to apply an electrostatic attraction force on the object upon energization of the electrode, and a plurality of actuators configured to deform the support layer.

According to another embodiment of the invention, there is provided a lithographic system, comprising: a reticle support configured to clamp a reticle in a path of a radiation beam so that the reticle produces a patterned beam, a projection system configured to project the patterned beam onto a target portion of a substrate, a substrate support configured to support the substrate during a lithographic process, and an electrostatic chuck coupled to the reticle support, the electrostatic chuck comprising: a substrate, a support layer to support an object, an electrode layer comprising an electrode and being disposed between the substrate and the support layer configured to apply an electrostatic attraction force on the object upon energization of the electrode, and a plurality of actuators configured to deform the support layer.

According to another embodiment of the invention, there is provided a method, comprising: determining surface irregularities of an object (to obtain a surface irregularities map of the object), determining a plurality of compensation values (i.e., a compensation data set) based on the irregularities, correlating the plurality of compensation values with a plurality of matrix points each of which is formed by one of a plurality of actuators disposed between a substrate and a support layer of an electrostatic chuck, determining an actuation level for each actuator corresponding to the associated compensation value being applied to the object at each of the plurality of matrix points, and applying the actuation level to each of the actuators to deform the support layer in accordance with the compensation values at each matrix point whilst the object is clamped on the support layer.

According to another embodiment of the invention, there is provided a method, comprising: utilizing an image quality evaluation system to determine a plurality of image errors affecting an image quality of the imaged object, determining a plurality of electrostatic compensation force values based on the plurality of image errors, correlating the plurality of electrostatic compensation force values with a plurality of matrix points formed by first and second evenly spaced sets of electrodes disposed in a substrate beneath the support layer of an electrostatic chuck, the first and second set of electrodes being generally orthogonally oriented to the other set, determining an energizing level for each electrode in the first and second set of electrodes corresponding to the associated compensation force value being applied to the object at each of the plurality of matrix points, and applying the energizing level to each electrode in the first and second set of electrodes to generate an electrostatic compensation force on the object at each of the plurality of matrix points.

In another embodiment of the invention, there is provided a method, comprising: utilizing an interferometer to determine surface irregularities of an object, determining a plurality of compensation values based on the irregularities, correlating the plurality of compensation values with a plurality of matrix points each of which is formed by one of a plurality of actuators disposed between a substrate and a support layer of an electrostatic chuck, determining an actuation level for each actuator corresponding to the associated compensation value being applied to the object at each of the plurality of matrix points, applying the actuation level to each of the actuators to deform the support layer in accordance with the compensation values at each matrix point whilst the object is clamped on the support layer, and determining, with the interferometer, the surface irregularities of the object remaining after application of the actuation level to each actuator.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIGS. 1A and 1B respectively depict reflective and transmissive lithographic apparatuses.

FIG. 2 depicts an example EUV lithographic apparatus.

FIG. 3 depicts an expanded perspective view of the electrostatic chuck assembly (i.e., the electrostatic chuck system) and associated table.

FIG. 4 shows a 2 dimensional array of actuators.

FIG. 5 shows a 1 dimensional array of actuators.

FIGS. 6A and 6B depict actuating actuator matrix points in order to apply a spatially compensating deformation force onto an object's irregular surface.

FIG. 7A illustrates a flow chart of a method for an image-compensating electrostatic chuck system.

FIG. 7B illustrates a detailed flow chart of a method for converting a surface irregularity map into the compensation values needed to compensate irregularities in FIG. 7A.

FIG. 8A illustrates a generalized flow chart of a method for an image-compensating electrostatic chuck system by actively measuring the image.

FIG. 8B illustrates a detailed flow chart of a method for converting the measured image errors into the compensation values needed to compensate irregularities of the image in FIG. 8A.

FIG. 9A is a flow chart illustrating an image error compensation method.

FIG. 9B illustrates a detailed flow chart of a method for converting the measured image errors into the compensation value needed to compensate irregularities of the image in FIG. 9A.

FIG. 10 shows an arc-shaped illumination of an imaging field in a stage scan direction.

FIG. 11 shows a linear slit illumination of an imaging field in a stage scan direction.

FIG. 12 is a flow chart illustrating hierarchy of correction implementation.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Overview

The present invention is directed to an image-compensating addressable electrostatic chuck system (herein for sake of simplicity also referred to as an electrostatic chuck, or simply chuck or chuck/clamp). This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment,” “an embodiment,” “an example embodiment,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, or acoustical devices and the like. Further, firmware, software, routines, and instructions may be described herein as performing certain actions. However, it should be appreciated that such descriptions are merely for convenience and that such actions in fact result from computing devices, processors, controllers, or other devices executing the firmware, software, routines, instructions, etc.

Detailed below are embodiments of an image-compensating electrostatic chuck system and methods of use thereof. In one embodiment an image-compensating electrostatic chuck itself comprises a substrate, a support layer to support an object such as a patterning device (e.g., a mask) MA (or other clamped object such as a substrate W to be imaged) and an actuator layer comprising a plurality of actuators configured to deform the support layer. Thereby the patterning device (e.g., a mask) MA (or other clamped object such as a substrate W to be imaged) may be controllably deformed when it is attracted by electrostatic force to the support layer by an electrode layer of the electrostatic chuck that comprises an electrode configured to apply an electrode attraction force on the object upon energization of the electrode. The plurality of actuators maybe ranged in a 2 dimensional array in a plane substantially parallel to a surface of the support layer on which the patterning device (e.g., a mask) MA (or other object such as a substrate W to be imaged) is supported. Alternatively, the plurality of actuators is arranged in a 1 dimensional array extending in a first direction. A calculated actuation level is applied to each of the actuators to deform the support layer so that the patterning device (e.g., a mask) MA (or other object such as a substrate W to be imaged) is deformed by a required amount at each matrix point at least during the time at which the matrix point is being scanned i.e., whilst the patterning device (e.g., a mask) MA (or other object such as a substrate W to be imaged) is in a predetermined position during a scanning motion relative to an illumination slit.

Additionally, there are provided embodiments for using the image-compensating electrostatic chuck to improve image quality. Each method can comprise placing a patterning device (e.g., a mask) MA (or other object such as a substrate W to be imaged) to be chucked to a support layer on the support layer, converting known or measured/imaged errors into a plurality of compensation values and associating those values with one of a plurality of matrix points formed by one of a plurality of actuators. Then calculating and applying actuation levels necessary to result in the associated compensation values being applied at each matrix point. At least one embodiment involves receiving surface irregularities of associated components (e.g., patterning device chuck, patterning device, substrate chuck, substrate, etc.) and converting the surface irregularities to compensation values. This embodiment does not involve any active measurements of the associated components or use of the imaging system to provide feedback as to the image quality.

Another embodiment utilizes an interferometer system to determine the surface irregularities of an object. This embodiment performs the same converting, associating, calculating, and applying methodology as described above. However, this embodiment is capable of using the interferometer to determine, after the application of the compensation values, if any remaining surface irregularities exist. And if any remaining surface irregularities do exist, the applied compensation value is modified to compensate the remaining irregularities.

Additionally, another embodiment utilizes an image quality evaluation system to determine a plurality of image errors affecting the image quality of the imaged patterning device (e.g., a mask) MA (or other clamped object such as a substrate W to be imaged). This procedure can be performed apriori to any imaging done in a system. Likewise, the image quality evaluation occurs in-situ in a lithographic tool, utilizing the imaging and image evaluation capabilities of the lithographic tool itself. In addition to possible surface irregularities in the chucks, reticles, and substrate wafers, the image quality evaluation system can correct a plurality of image errors (e.g., image curvature, image focus, image distortion, image astigmatism, etc.). This embodiment is also capable of using the image quality evaluation system to determine, after the application of the compensation value, if any remaining image quality errors exist. And if any remaining image quality errors do exist, modify the applied compensation value so as to compensate the remaining errors.

In yet another embodiment, the above methods can be utilized to correct for scanning inaccuracies that generate positional errors perpendicular to a patterning device (e.g., a mask) MA (or other clamped object such as a substrate W to be imaged) that effect image quality. The electrodes are typically addressed in a line perpendicular to the scan direction of a chucked patterning device (e.g., a mask) MA (or other clamped object such as a substrate W to be imaged). In another embodiment, the electrodes can be addressed in an arc shape, perpendicular to the scan direction of a chucked patterning device (e.g., a mask) MA (or other clamped object such as a substrate W to be imaged).

Before describing such embodiments in more detail, however, it is instructive to present an example environment in which embodiments of the present invention can be implemented.

### II. AN EXAMPLE LITHOGRAPHIC ENVIRONMENT

A. Example Reflective and Transmissive Lithographic Systems

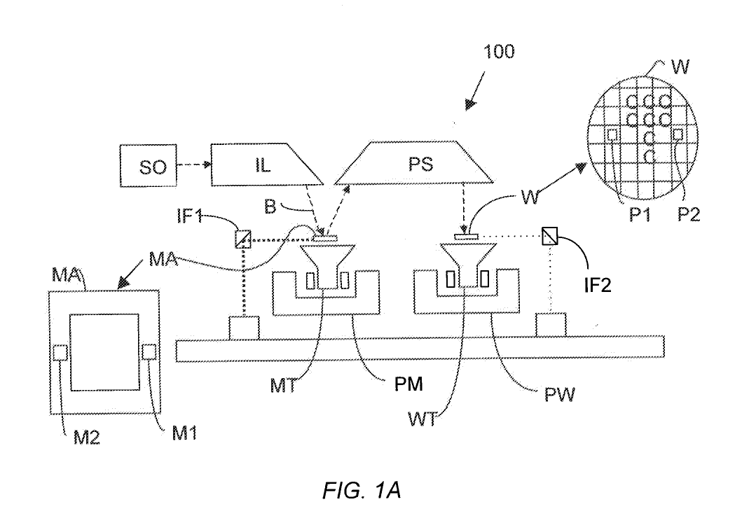

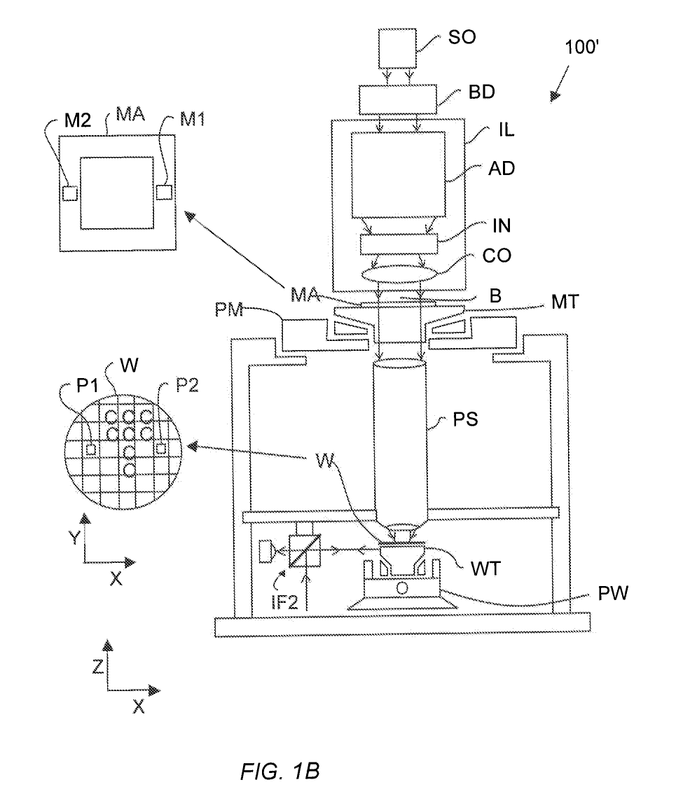

FIGS. 1A and 1B schematically depict lithographic apparatus 100 and lithographic apparatus 100′, respectively. Lithographic apparatus 100 and lithographic apparatus 100′ each include: an illumination system (illuminator) IL configured to condition a radiation beam B (e.g., DUV or EUV radiation); a support structure (e.g., a mask table) MT configured to support a patterning device (e.g., a mask, a reticle, or a dynamic patterning device) MA and connected to a first positioner PM configured to accurately position the patterning device MA; and a substrate table (e.g., a wafer table) WT configured to hold a substrate (e.g., a resist coated wafer) W and connected to a second positioner PW configured to accurately position the substrate W. Lithographic apparatuses 100 and 100′ also have a projection system PS configured to project a pattern imparted to the radiation beam B by patterning device MA onto a target portion (e.g., comprising one or more dies) C of the substrate W. In lithographic apparatus 100 the patterning device MA and the projection system PS is reflective, and in lithographic apparatus 100′ the patterning device MA and the projection system PS is transmissive.

The illumination system IL may include various types of optical components, such as refractive, reflective, magnetic, electromagnetic, electrostatic, or other types of optical components, or any combination thereof, for directing, shaping, or controlling the radiation B.

The support structure MT holds the patterning device MA in a manner that depends on the orientation of the patterning device MA, the design of the lithographic apparatuses 100 and 100′, and other conditions, such as for example whether or not the patterning device MA is held in a vacuum environment. The support structure MT may use mechanical, vacuum, electrostatic, or other clamping techniques to hold the patterning device MA. The support structure MT may be a frame or a table, for example, which may be fixed or movable, as required. The support structure MT may ensure that the patterning device is at a desired position, for example with respect to the projection system PS.

The term “patterning device” MA should be broadly interpreted as referring to any device that may be used to impart a radiation beam B with a pattern in its cross-section, such as to create a pattern in the target portion C of the substrate W. The pattern imparted to the radiation beam B may correspond to a particular functional layer in a device being created in the target portion C, such as an integrated circuit.

The patterning device MA may be transmissive (as in lithographic apparatus 100′ of FIG. 1B) or reflective (as in lithographic apparatus 100 of FIG. 1A). Examples of patterning devices MA include reticles, masks, programmable mirror arrays, and programmable LCD panels. Masks are well known in lithography, and include mask types such as binary, alternating phase shift, and attenuated phase shift, as well as various hybrid mask types. An example of a programmable mirror array employs a matrix arrangement of small mirrors, each of which may be individually tilted so as to reflect an incoming radiation beam in different directions. The tilted mirrors impart a pattern in the radiation beam B that is reflected by the mirror matrix.

The term “projection system” PS may encompass any type of projection system, including refractive, reflective, catadioptric, magnetic, electromagnetic and electrostatic optical systems, or any combination thereof, as appropriate for the exposure radiation being used, or for other factors, such as the use of an immersion liquid or the use of a vacuum. A vacuum environment may be used for EUV or electron beam radiation since other gases may absorb too much radiation or electrons. A vacuum environment may therefore be provided to the whole beam path with the aid of a vacuum wall and vacuum pumps.

Lithographic apparatus 100 and/or lithographic apparatus 100′ may be of a type having two (dual stage) or more substrate tables (and/or two or more mask tables) WT. In such “multiple stage” machines the additional substrate tables WT may be used in parallel, or preparatory steps may be carried out on one or more tables while one or more other substrate tables WT are being used for exposure.

Referring to FIGS. 1A and 1B, the illuminator IL receives a radiation beam from a radiation source SO. The source SO and the lithographic apparatuses 100, 100′ may be separate entities, for example when the source SO is an excimer laser. In such cases, the source SO is not considered to form part of the lithographic apparatuses 100 or 100′, and the radiation beam B passes from the source SO to the illuminator IL with the aid of a beam delivery system BD (FIG. 1B) comprising, for example, suitable directing mirrors and/or a beam expander. In other cases, the source SO may be an integral part of the lithographic apparatuses 100, 100′—for example when the source SO is a mercury lamp. The source SO and the illuminator IL, together with the beam delivery system BD, if required, may be referred to as a radiation system.

The illuminator IL may comprise an adjuster AD (FIG. 1B) configured to adjust the angular intensity distribution of the radiation beam. Generally, at least the outer and/or inner radial extent (commonly referred to as σ-outer and σ-inner, respectively) of the intensity distribution in a pupil plane of the illuminator may be adjusted. In addition, the illuminator IL may comprise various other components (FIG. 1B), such as an integrator IN and a condenser CO. The illuminator IL may be used to condition the radiation beam B, to have a desired uniformity and intensity distribution in its cross section.

Referring to FIG. 1A, the radiation beam B is incident on the patterning device (e.g., mask) MA, which is held on the support structure (e.g., mask table) MT, and is patterned by the patterning device MA. In lithographic apparatus 100, the radiation beam B is reflected from the patterning device (e.g., mask) MA. After being reflected from the patterning device (e.g., mask) MA, the radiation beam B passes through the projection system PS, which focuses the radiation beam B onto a target portion C of the substrate W. With the aid of the second positioner PW and position sensor IF2 (e.g., an interferometric device, linear encoder, or capacitive sensor), the substrate table WT may be moved accurately, e.g., so as to position different target portions C in the path of the radiation beam B. Similarly, the first positioner PM and another position sensor IF1 may be used to accurately position the patterning device (e.g., mask) MA with respect to the path of the radiation beam B. Patterning device (e.g., mask) MA and substrate W may be aligned using mask alignment marks M1, M2 and substrate alignment marks P1, P2.

Referring to FIG. 1B, the radiation beam B is incident on the patterning device (e.g., mask MA), which is held on the support structure (e.g., mask table MT), and is patterned by the patterning device. Having traversed the mask MA, the radiation beam B passes through the projection system PS, which focuses the beam onto a target portion C of the substrate W. With the aid of the second positioner PW and position sensor IF (e.g., an interferometric device, linear encoder, or capacitive sensor), the substrate table WT can be moved accurately, e.g., so as to position different target portions C in the path of the radiation beam B. Similarly, the first positioner PM and another position sensor (which is not explicitly depicted in FIG. 1B) can be used to accurately position the mask MA with respect to the path of the radiation beam B, e.g., after mechanical retrieval from a mask library, or during a scan.

In general, movement of the mask table MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (known as scribe-lane alignment marks). Similarly, in situations in which more than one die is provided on the mask MA, the mask alignment marks may be located between the dies.

The lithographic apparatuses 100 and 100′ may be used in at least one of the following modes:

1. In step mode, the support structure (e.g., mask table) MT and the substrate table WT are kept essentially stationary, while an entire pattern imparted to the radiation beam B is projected onto a target portion C at one time (i.e., a single static exposure). The substrate table WT is then shifted in the X and/or Y direction so that a different target portion C may be exposed.

2. In scan mode, the support structure (e.g., mask table) MT and the substrate table WT are scanned synchronously while a pattern imparted to the radiation beam B is projected onto a target portion C (i.e., a single dynamic exposure). The velocity and direction of the substrate table WT relative to the support structure (e.g., mask table) MT may be determined by the (de-)magnification and image reversal characteristics of the projection system PS.

3. In another mode, the support structure (e.g., mask table) MT is kept substantially stationary holding a programmable patterning device, and the substrate table WT is moved or scanned while a pattern imparted to the radiation beam B is projected onto a target portion C. A pulsed radiation source SO may be employed and the programmable patterning device is updated as required after each movement of the substrate table WT or in between successive radiation pulses during a scan. This mode of operation may be readily applied to maskless lithography that utilizes programmable patterning device, such as a programmable mirror array of a type as referred to herein.

Combinations and/or variations on the described modes of use or entirely different modes of use may also be employed.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion,” respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

In a further embodiment, lithographic apparatus 100 includes an extreme ultraviolet (EUV) source (SO), which is configured to generate a beam of EUV radiation for EUV lithography. In general, the EUV source is configured in a radiation system (see below), and a corresponding illumination system is configured to condition the EUV radiation beam of the EUV source.

B. Example EUV Lithographic Apparatus

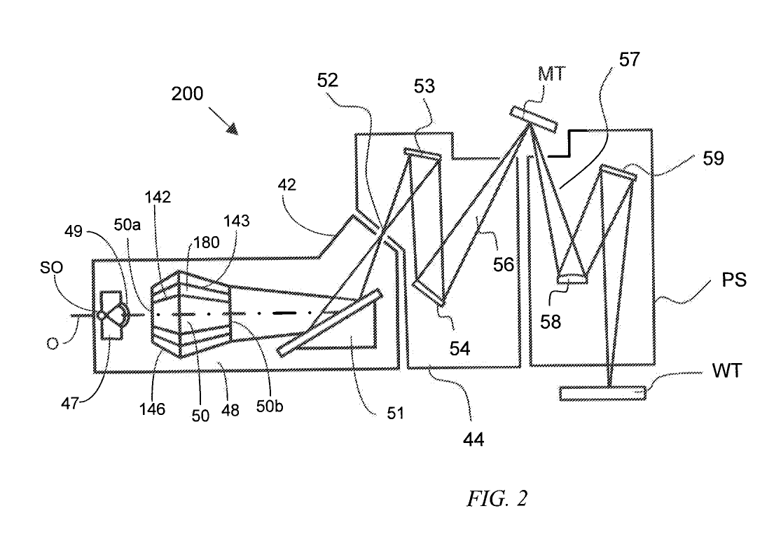

FIG. 2 schematically depicts an exemplary EUV lithographic apparatus 200 according to an embodiment of the present invention. In FIG. 2, EUV lithographic apparatus 200 includes a radiation system 42, an illumination optics unit 44, and a projection system PS. The radiation system 42 includes a radiation source SO, in which a beam of radiation may be formed by a discharge plasma. In an embodiment, EUV radiation may be produced by a gas or vapor, for example, from Xe gas, Li vapor, or Sn vapor, in which a very hot plasma is created to emit radiation in the EUV range of the electromagnetic spectrum. The very hot plasma can be created by generating at least partially ionized plasma by, for example, an electrical discharge. Partial pressures of, for example, 10 Pa of Xe, Li, Sn vapor or any other suitable gas or vapor may be required for efficient generation of the radiation. The radiation emitted by radiation source SO is passed from a source chamber 47 into a collector chamber 48 via a gas barrier or contaminant trap 49 positioned in or behind an opening in source chamber 47. In an embodiment, gas barrier 49 may include a channel structure.

Collector chamber 48 includes a radiation collector 50 (which may also be called collector mirror or collector) that may be formed from a grazing incidence collector. Radiation collector 50 has an upstream radiation collector side 50a and a downstream radiation collector side 50b, and radiation passed by collector 50 can be reflected off a grating spectral filter 51 to be focused at a virtual source point 52 at an aperture in the collector chamber 48. Radiation collectors 50 are known to skilled artisans.

From collector chamber 48, a beam of radiation 56 is reflected in illumination optics unit 44 via normal incidence reflectors 53 and 54 onto a reticle or mask (not shown) positioned on reticle or mask table MT. A patterned beam 57 is formed, which is imaged in projection system PS via reflective elements 58 and 59 onto a substrate (not shown) supported on wafer stage or substrate table WT. In various embodiments, illumination optics unit 44 and projection system PS may include more (or fewer) elements than depicted in FIG. 2. For example, grating spectral filter 51 may optionally be present, depending upon the type of lithographic apparatus. Further, in an embodiment, illumination optics unit 44 and projection system PS may include more mirrors than those depicted in AG. 2. For example, projection system PS may incorporate one to four reflective elements in addition to reflective elements 58 and 59. In FIG. 2, reference number 180 indicates a space between two reflectors, e.g., a space between reflectors 142 and 143.

In an embodiment, collector mirror 50 may also include a normal incidence collector in place of or in addition to a grazing incidence mirror. Further, collector mirror 50, although described in reference to a nested collector with reflectors 142, 143, and 146, is herein further used as example of a collector.

Further, instead of a grating 51, as schematically depicted in FIG. 2, a transmissive optical filter may also be applied. Optical filters transmissive for EUV, as well as optical filters less transmissive for or even substantially absorbing UV radiation, are known to skilled artisans. Hence, the use of “grating spectral purity filter” is herein further indicated interchangeably as a “spectral purity filter,” which includes gratings or transmissive filters. Although not depicted in FIG. 2, EUV transmissive optical filters may be included as additional optical elements, for example, configured upstream of collector mirror 50 or optical EUV transmissive filters in illumination unit 44 and/or projection system PS.

The terms “upstream” and “downstream,” with respect to optical elements, indicate positions of one or more optical elements “optically upstream” and “optically downstream,” respectively, of one or more additional optical elements. Following the light path that a beam of radiation traverses through lithographic apparatus 200, a first optical elements closer to source SO than a second optical element is configured upstream of the second optical element; the second optical element is configured downstream of the first optical element. For example, collector mirror 50 is configured upstream of spectral filter 51, whereas optical element 53 is configured downstream of spectral filter 51.

All optical elements depicted in FIG. 2 (and additional optical elements not shown in the schematic drawing of this embodiment) may be vulnerable to deposition of contaminants produced by source SO, for example, Sn. Such may be the case for the radiation collector 50 and, if present, the spectral purity filter 51. Hence, a cleaning device may be employed to clean one or more of these optical elements, as well as a cleaning method may be applied to those optical elements, but also to normal incidence reflectors 53 and 54 and reflective elements 58 and 59 or other optical elements, for example additional mirrors, gratings, etc.

Radiation collector 50 can be a grazing incidence collector, and in such an embodiment, collector 50 is aligned along an optical axis O. The source SO, or an image thereof, may also be located along optical axis O. The radiation collector 50 may comprise reflectors 142, 143, and 146 (also known as a “shell” or a Wolter-type reflector including several Wolter-type reflectors). Reflectors 142, 143, and 146 may be nested and rotationally symmetric about optical axis O. In FIG. 2, an inner reflector is indicated by reference number 142, an intermediate reflector is indicated by reference number 143, and an outer reflector is indicated by reference number 146. The radiation collector 50 encloses a certain volume, i.e., a volume within the outer reflector(s) 146. Usually, the volume within outer reflector(s) 146 is circumferentially closed, although small openings may be present.

Reflectors 142, 143, and 146 respectively may include surfaces of which at least portion represents a reflective layer or a number of reflective layers. Hence, reflectors 142, 143, and 146 (or additional reflectors in the embodiments of radiation collectors having more than three reflectors or shells) are at least partly designed for reflecting and collecting EUV radiation from source SO, and at least part of reflectors 142, 143, and 146 may not be designed to reflect and collect EUV radiation. For example, at least part of the back side of the reflectors may not be designed to reflect and collect EUV radiation. On the surface of these reflective layers, there may in addition be a cap layer for protection or as optical filter provided on at least part of the surface of the reflective layers.

The radiation collector 50 may be placed in the vicinity of the source SO or an image of the source SO. Each reflector 142, 143, and 146 may comprise at least two adjacent reflecting surfaces, the reflecting surfaces further from the source SO being placed at smaller angles to the optical axis O than the reflecting surface that is closer to the source SO. In this way, a grazing incidence collector 50 is configured to generate a beam of (E)UV radiation propagating along the optical axis O. At least two reflectors may be placed substantially coaxially and extend substantially rotationally symmetric about the optical axis O. It should be appreciated that radiation collector 50 may have further features on the external surface of outer reflector 146 or further features around outer reflector 146, for example a protective holder, a heater, etc.

In the embodiments described herein, the terms “lens” and “lens element,” where the context allows, may refer to any one or combination of various types of optical components, comprising refractive, reflective, magnetic, electromagnetic and electrostatic optical components.

Further, the terms “radiation” and “beam” used herein encompass all types of electromagnetic radiation, comprising ultraviolet (UV) radiation (e.g., having a wavelength λ of 365, 248, 193, 157 or 126 nm), extreme ultra-violet (EUV or soft X-ray) radiation (e.g., having a wavelength in the range of 5-20 nm, e.g., 13.5 nm), or hard X-ray working at less than 5 nm, as well as particle beams, such as ion beams or electron beams. Generally, radiation having wavelengths between about 780-3000 nm (or larger) is considered IR radiation. UV refers to radiation with wavelengths of approximately 100-400 nm. Within lithography, it is usually also applied to the wavelengths, which can be produced by a mercury discharge lamp: G-line 436 nm; H-line 405 nm; and/or I-line 365 nm. Vacuum UV, or VUV (i.e., UV absorbed by air), refers to radiation having a wavelength of approximately 100-200 nm. Deep UV (DUV) generally refers to radiation having wavelengths ranging from 126 nm to 428 nm, and in an embodiment, an excimer laser can generate DUV radiation used within lithographic apparatus. It should be appreciated that radiation having a wavelength in the range of, for example, 5-20 nm relates to radiation with a certain wavelength band, of which at least part is in the range of 5-20 nm.

### III. AN IMAGE-COMPENSATING ELECTROSTATIC CHUCK (OR CLAMP)

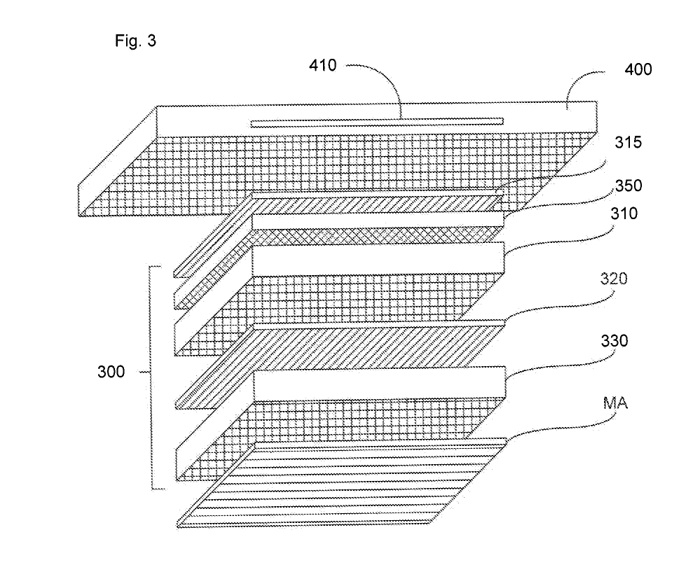

FIG. 3 schematically depicts an expanded electrostatic chuck assembly 300 and associated table 400, according to an embodiment of the present invention. In FIG. 3, the electrostatic chuck assembly 300 includes a chuck substrate 310, at least one electrode layer 315, 320, a support layer 330 (e.g., in the form of a pin chuck) and an actuator layer 350. Electrostatic chuck assembly 300 is configured to support (i.e., clamp) a patterning device (e.g., a mask MA) in place during a lithographic operation.

In one example, chuck substrate 310 provides backing and support for the entire assembly and can exceed the footprint of the electrode layer(s) 315, 320 and support layer 330.

In one example, electrode layer 320 itself, which may be directly on top of the chuck substrate 310 or disposed therein, is comprised of at least one electrode. The electrode layer 320 is disposed between the substrate 310 and the support layer 330. When the electrode of the electrode layer 320 is energized an electrostatic attraction force is applied on the patterning device (e.g., a mask) MA. Thus the patterning device (e.g., a mask) MA is removeably attachable to the chuck 300, for example by an electrostatic force. The patterning device (e.g., a mask) MA is separate from the electrostatic chuck 300 and table 400. The patterning device does not comprise any actuators. The patterning device may be a passive object.

The electrode layer 320 may comprise more than one electrode. The number, size and shape of electrodes can depend on a number of factors, such as overall footprint (i.e., size) of the desired electrostatic clamping force, required density (i.e., spacing between parallel electrodes) to effectuate the needed electrostatic force, and design characteristics of the required electrostatic force field.

In an embodiment the chuck 300 may comprise a further electrode layer 315 comprising at least one electrode configured to attach the chuck 300 to a moveable table 400. The moveable table 400 may comprise a table electrode 410. An electrostatic field generated between the further electrode layer 315 and the table electrode 410 is effective to clamp the chuck 300 to the table 400. Alternative ways of attaching the chuck 300 to the table 400 may be provided, for example mechanical fixing.

In one example, support layer 330 completes an encapsulation of the electrode layer 320 and provides the physical support for any object that is being clamped to the chuck. For example, the support layer 330 is commonly comprised of a plurality of very small glass protrusions with flat ends. All or some of the chuck substrate 310, electrode layer(s) 315, 320, support layer 330 and actuator layer 350 are attached together, e.g., by being laminated, glued, bonded or fixed together.

In one example, a patterning device (e.g., a mask) MA can be placed onto the outer surface of the support layer 330 and be fully supported. In one example, support layer 330 is made from glass so that pin chuck 330 is not conductive and does not have any effect on the electrostatic force coupling from the electrode layer 320 to the patterning device (e.g., a mask) MA. The support layer 330 does not clamp (i.e., hold in place) the patterning device (e.g., a mask) MA, rather the clamping is provided by the electrostatic field generated by energizing the electrode(s) that comprise(s) the electrode layer 320, the support layer 330 merely provides the physical contact support. The area above the electrode layer 320 where the electrostatic field is generated can be referred to as the electrostatic clamp area of the image-compensating addressable electrostatic chuck.

In an example, the chuck 300 is provided with the actuator layer 350 which comprises a plurality of actuators 351. In an example the actuators 351 are configured to deform the support layer 330. By deforming the support layer 330, when a patterning device (e.g., a mask) MA is clamped to the support layer 330 by an electrostatic force generated by the electrode layer 320, the deformations of the support layer 330 are transmitted to the patterning device (e.g., a mask) MA. Therefore, the plurality of actuators 350 can be used to deform the patterning device (e.g., a mask) MA.

In one embodiment the actuator layer 350 is positioned on a side of the substrate 310 opposite to the electrode layer 320. However, the actuator layer 350 may be positioned anywhere so long as the actuator layer 350 can deform the support layer 330. For example, the actuator layer 350 maybe positioned in any of the following positions from a non-limiting list: between the electrode layer 320 and the support layer 330, between the electrode layer 320 and the substrate 310, between the further electrode 315 and the table 400, in the table 400 on either side of the table electrode 410.

The number, size and position of the actuators 351 of the actuator layer 350 are chosen according to need. In one example, the actuators 351 are piezoelectric actuators.

The spacing between adjacent actuators 351 maybe uniform or non uniform in one or both of orthogonal directions. In one example the actuators 351 maybe controllable in direction of actuation and/or magnitude of actuation. This enables, for example, portions of both concave and convex shapes of the patterning device (e.g., a mask) MA to be corrected to flat using the plurality of actuators 351 under the concave and/or convex portion.

Thus, the clamping and compensating functions are independent allowing maximum clamping force to be achieved. Correction in both +Z and −Z is possible. A high density of actuators 351 is possible and actuators 351 and control components are readily available (e.g., for use in printer heads).

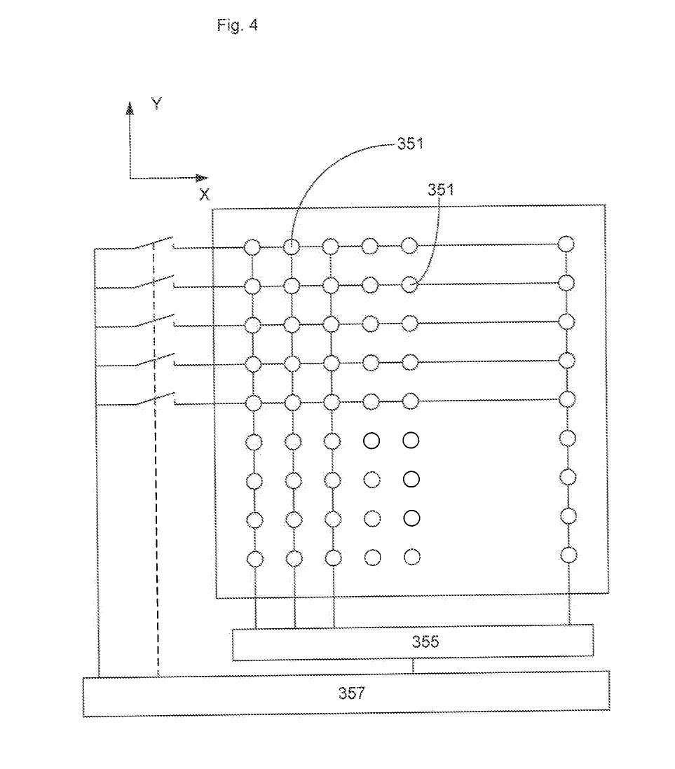

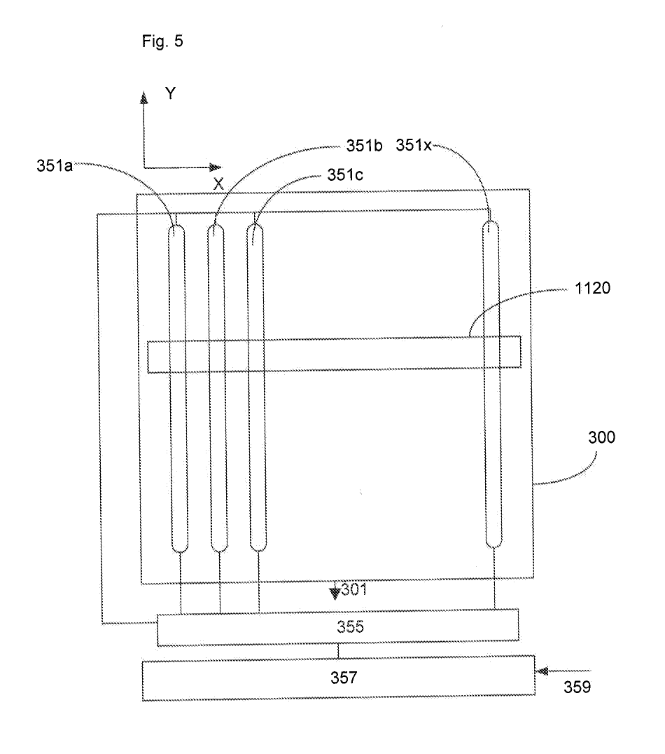

FIG. 4 and FIG. 5 show schematically, in plan, different embodiments of the actuators 351. FIG. 4 shows actuators 351 of the plurality of actuators in a 2 dimensional array. For the sake of description and in no other way limiting, actuators 351 are shown as being circular, in plan, and regularly spaced in a 2 dimensional array with two principle axis which are orthogonal to one another. Each actuator 351 is individually addressable by applying a voltage over the actuators 351 by an analogue multiplexer 355. A logic switch 357 selects the correct row of actuators 351. In one embodiment, the principle axis of the plurality of actuators 350 are the x direction and the y direction that are orthogonal to one another. In an alternative embodiment, each of the actuators 351 may be individually addressable. That may be more difficult to manufacture and electrically connect but results in easier control of the actuation level. Conversely, in the embodiment of FIG. 4 it may be non-trivial to apply the correct energizing level to each actuator because a particular x, y point shares the actuation level with the other points showing the same x or y electrode.

Once a desired deformation of the support layer 330 has been calculated, the actuators 351 of the actuator layer 350 may be controlled to deform the support layer 330 by the required amounts in the required areas. This may be done after the patterning device (e.g., a mask) MA 340 has been attached to the support layer 330 by the electrode layer 320 or before the patterning device (e.g., a mask) MA has been attached or clamped to the support layer 330. The patterning device (e.g., a mask) MA takes up the shape similar to that of the support layer 330. This makes it possible to deform the patterning device (e.g., a mask) MA thereby, for example, to make the patterning device (e.g., a mask) MA closer to being perfectly flat than would be the case in the absence of the actuators 351 of the of actuator layer 350 deforming the support layer 330. During a scanning movement the actuation level of each of the actuators 351 can be maintained constant, thereby providing easy control.

In FIG. 5 the electrodes 351a-351x are arranged in a 1 dimensional array. The plurality of electrodes 351a-351x are arranged to deform a portion of the support layer 330 that is elongated in the y direction (the direction of scanning of the chuck 300 relative to the illumination slit 1120). The 1 dimensional array extends in the x direction (in a first direction). During scanning the chuck 300 moves in the y direction as illustrated by arrow 301. The logic module 357 is provided with data 359 relating to the position of the chuck 300 in the y direction relative to the illumination slit 1120. From a knowledge of the required actuation levels at each position of the patterning device (e.g., a mask) MA in the x and y directions, each of the actuators 351a-351x maybe actuated at the appropriate time by the required level for the matrix points of the portion of the object positioned under the illumination slit 1120.

Thus, in comparison to the embodiment of FIG. 4, each of the actuators 351a-351x of the actuator layer 350 forms a plurality of the plurality matrix points. The plurality of the plurality of matrix points are in a line substantially parallel to a scanning motion of the patterning device (e.g., a mask) MA (i.e., aligned in the y direction). During correlating the required compensation values of the plurality of the plurality of matrix points for each of the actuators are correlated to a time of a scanning motion at which points of the matrix are under the illumination slit 1120 or patterning device (e.g., a mask) MA (or chuck) is in a predetermined position during a scanning motion relative to the illumination slit 1120.

Therefore, the actuation value is applied at least partly during the scanning motion and during the applying the actuation level applied to each of the actuators 351a-351x varies according to the compensation value for the time of the scanning motion and/or a position of the object relative to the illumination slit 1120.

In at least one embodiment, the patterning device (e.g., a mask) MA to be clamped has fairly consistent deformations. In particular, the patterning device (e.g., a mask) MA is often deformed (e.g., curved) along the edges of the patterning device (e.g., a mask) MA. The patterning device (e.g., a mask) MA can take a bowed shape where the center is either above or below the outer edges of the patterning device (e.g., a mask) MA. Accordingly the chuck 300 should desirably provide more precise control of the deformation at the edges of the chuck 300 area. The actuators 351 are more densely placed at the edges of the electrostatic clamping area to achieve this.

In at least one embodiment of the present invention, the electrostatic chuck 300 may support an object different to the patterning device. For example the chuck 300 may support a substrate W to be imaged.

The chuck 300 may be a chuck other than an electrostatic chuck. For example, the chuck 300 may hold the patterning device (e.g., a mask) MA (or other clamped object such as a substrate W to be imaged) to the support layer 330 by a different method such as by use of an under pressure clamp (e.g., a vacuum clamp).

JP 2009-164284, which is incorporated by reference herein in its entirety, discloses a pattern formation board that is attachable to a chuck. The pattern formation board has reflective and absorbing layers to form a pattern to be transferred to a substrate. The reflective and absorbing layers are laminated with a base substance part and piezoelectric elements. The piezoelectric elements can be energized to deform the reflective and absorbing layers. This system has the disadvantage that a separate array of piezoelectric elements needs to be provided for each different pattern to be imaged. That is, the system of JP 2009-164284 requires special manufacture of the patterning device to incorporate the piezoelectric elements whereas the present invention can be used in conjunction with conventional patterning devices (e.g., a mask) and additionally with other objects such as a substrate (which is not practical with the system of JP 2009-164284 because an array of piezoelectric elements would need to be laminated to each substrate).

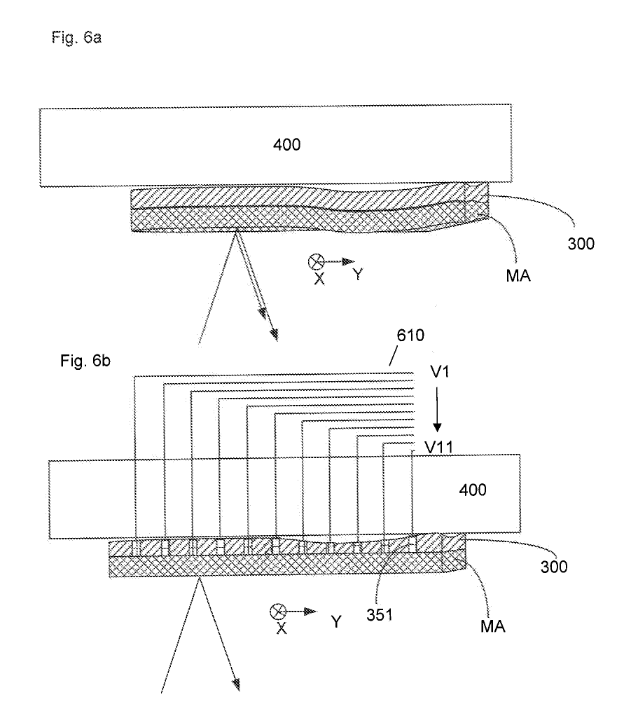

FIG. 6A schematically shows, in cross-section, a reticle with an unflatness mounted on a chuck.

FIG. 6B schematically shows, in cross-section, chuck 300, in which each actuator 351 is electrically individually addressable, according to an embodiment of the present invention. The unflatness in FIG. 6A has been corrected. Element 610 is a series of eleven exemplary electrical connections to eleven illustrative actuators 351 (shown here as cross sections). The electrical connections 610 are provided with an actuation level, shown in FIG. 6 as voltages V1-V11. While voltage is the most common measure of actuation level for the actuators 351 in the present invention, the actuation level is not limited to being defined by only voltage. The application via the electrical connections of an actuation level to the actuators 351 generates an extension (or contraction) of the actuator proportional to the actuation level and thereby a deformation of the support layer 310 and so the desired deformation of the patterning device (e.g., a mask) MA.

A patterning device (e.g., a mask) MA may contain surface irregularities (illustrated in FIG. 6A by the curvature of the illustrative patterning device (e.g., a mask) MA) that can be corrected by deformations induced by the actuators 351 of the actuator layer 350. Because a plurality of actuation levels (V1-V11) can be communicated via the plurality of electrical connections 610 to the plurality of actuators 351, a plurality of deformations can be generated in the support layer 330. This means that one or more actuators can generate a positive or negative deviation (+z or −z) in the support surface of the support layer 330 compared to the surrounding support surface. In one example, this principle can be extrapolated to the two dimensional embodiments disclosed in FIG. 4 and FIG. 5 above, where the deformation is applied to a patterning device (e.g., a mask) MA in two dimensions based on the actuation level applied to the plurality of orthogonally disposed actuators 351 or the one dimensional actuator array. However, the invention is not limited to merely providing correction of deformation errors.

In one example, deformation can be applied to a clamped patterning device (e.g., a mask) MA (or other clamped object such as a substrate W to be imaged) to correct surface irregularities of the chuck/clamp, to correct for imaging errors of the projection system, to correct for deformation/irregularity of the target substrate, and to correct for scanning errors that are perpendicular to the direction of scanning. Therefore, it is important to note that the plurality of actuators 351 is not only used to correct for patterning device (e.g., a mask) MA (or substrate W) deformations, but can induce patterning device (e.g., mask) MA (or substrate W) deformations to compensate the image for various other lithographic system errors and thus improve total image quality, which in turn, minimizes manufacturing defects and improves efficiency.

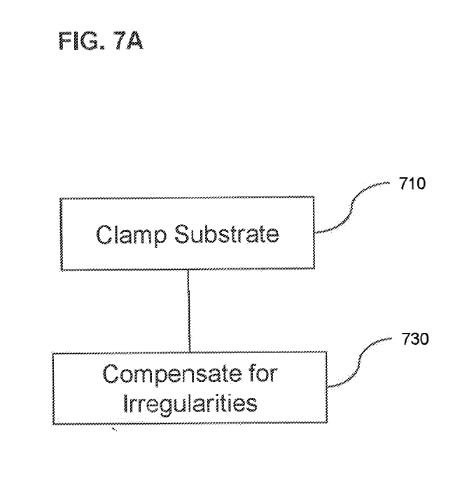

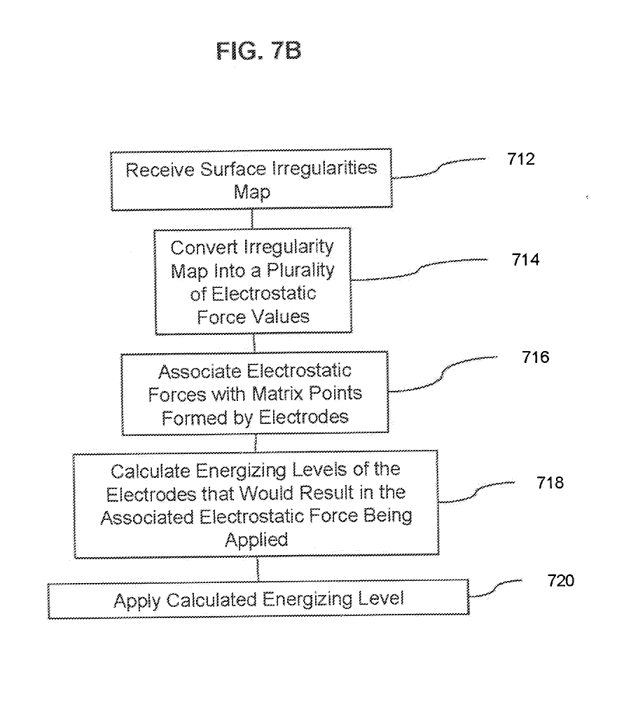

FIG. 7A illustrates a method for using an electrostatic chuck to maximize manufacturing efficiencies by improving the quantity of successfully imaged devices, according to an embodiment of the present invention. One method of using the electrostatic chuck system contains two steps: clamping the patterning device (e.g., a mask) MA 710 and compensating for irregularities 730. Additional steps can be employed.

The embodiment of FIG. 7B comprises five more steps between clamping (at step 710) and compensating (at step 730). These five steps are receiving surface irregularities map 712, converting the irregularity map into a plurality of compensation values 714, associating or correlating the compensation values with matrix points each of which formed by one of the plurality of actuators 716, determining (e.g., calculating) actuation levels of the actuators 351 that would result in the associated compensation values being applied 718, and applying the calculated actuation level 720.

In an example the compensation value is a displacement value that may be indicative of a displacement of a matrix point from an imaginary plane (e.g., perpendicular to the z axis). In an embodiment the actuation level maybe a signal proportional to the direction and/or magnitude of the compensation value required by the corresponding actuator 351 to achieve the compensation value at the associated matrix point. Therefore, the actuation level is applied to each of the actuators 351 to deform the support layer 330 in accordance with the compensation values at each matrix point whilst the patterning device (e.g., a mask) MA is clamped on the support layer 330.

In the case of the embodiment of FIG. 5, during the correlating the compensation values of the plurality of the plurality of the matrix points for each of the actuators 351 are correlated to a time at which the matrix points are scanned during a scanning motion and/or a position of the chuck 300 during a scanning motion relative to the illumination slit 1120. Then, the applying takes place at least partly during the scanning motion. During the applying the actuation level applied to each of the actuators 351 varies with time/position according to the compensation value for the time of the scanning motion and/or a position of the patterning device (e.g., a mask) MA relative to the illumination slit.

In an embodiment of the present invention, the patterning device (e.g., a mask) MA to be held in place (i.e., “chucked”) is first clamped (at step 710), via a standard uniform non-customized electrostatic field, to an image-compensating addressable electrostatic chuck 300 (as shown, for example, in FIG. 3). A surface irregularities map is received (at step 712) by a dynamic deformation controller (not shown). The controller contains internal logic to convert (at step 714) the received map (from step 712) into a plurality of compensation values (e.g., the amount of deformation that will be needed to compensate for the surface irregularities). At step 716, the controller associates each of the compensation values with a matrix point each of which is formed by one of the plurality of actuators 351. Next, at step 718, an actuation level for each actuator 351 is calculated such that the compensation value is applied to the clamped patterning device (e.g., a mask) MA. And finally, at step 720, the calculated actuation level is applied by the controller to the actuators 351 of the electrostatic chuck 300. By applying the actuation level to the actuators 351, step 730 of compensating for the irregularities is accomplished. After the addressable actuation levels are applied to the electrostatic chuck actuators 351, the deformation may be non-uniform and each of a plurality of actuators 351 may be held at a different actuation level. The differing actuation levels create different deformation forces on the patterning device (e.g., a mask) MA being chucked. This spatially differing deformation allows the chuck 300 to reshape the patterning device (e.g., a mask) MA being held so as to correct for surface irregularities of the patterning device (e.g., a mask) MA.

The image-compensating addressable electrostatic chuck 300 is not limited to correcting surface irregularities of the patterning device (e.g., a mask) MA (or other clamped object such as a substrate W to be imaged) being clamped. The image-compensating addressable electrostatic chuck can also correct deformations if the support layer 330 and/or underlying chuck substrate 310 has manufacturing defects that cause the patterning device (e.g., a mask) MA (or other clamped object such as a substrate W to be imaged) being clamped to be deformed. The manufacturing irregularities causing the deformation of the patterning device (e.g., a mask) MA (or other clamped object such as a substrate W to be imaged) to be clamped must be mapped (i.e., identified) in advance, prior to correction. Likewise, if mapped irregularities of both the patterning device (e.g., a mask) MA (or other clamped object such as a substrate W to be imaged) and the substrate/pin chuck exist, the controller can combine the two data sets and produce a correction that will compensate the image for both types of errors.

In another embodiment, image errors (e.g., image curvature, image focus, image distortion, astigmatism, etc.) created by the projection system are present and applying a non-uniform deformation to the patterning device (e.g., a mask) MA (or other clamped object such as a substrate W to be imaged) compensates for the image errors. In some embodiments, the details of the image errors have been previously quantified. This data can be used by the controller to compensate for the image error, either alone or in combination with correcting the manufacturing defects of the chuck substrate/pin chuck and/or the surface irregularities of the patterning device (e.g., a mask) MA (or other clamped object such as a substrate W to be imaged) itself. In another embodiment, repeatable scan errors that are perpendicular to the direction of scan can be compensated for. Data regarding the scan errors can also be received by the controller and compensated for by modifying the electrostatic force applied to the patterning device (e.g., a mask) MA (or other clamped object such as a substrate W to be imaged) at the proper point during the scan. Correcting for the scanning errors can be done alone or in combination with compensation for the chuck substrate/pin chuck manufacturing, errors, the patterning device (e.g., a mask) MA (or other clamped object such as a substrate W to be imaged) surface irregularities, and the image errors introduced by the projection system.

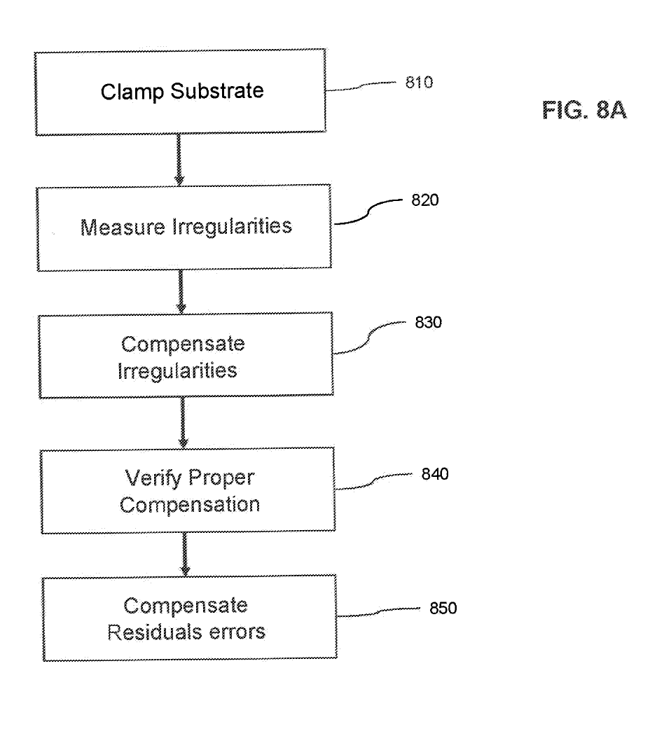

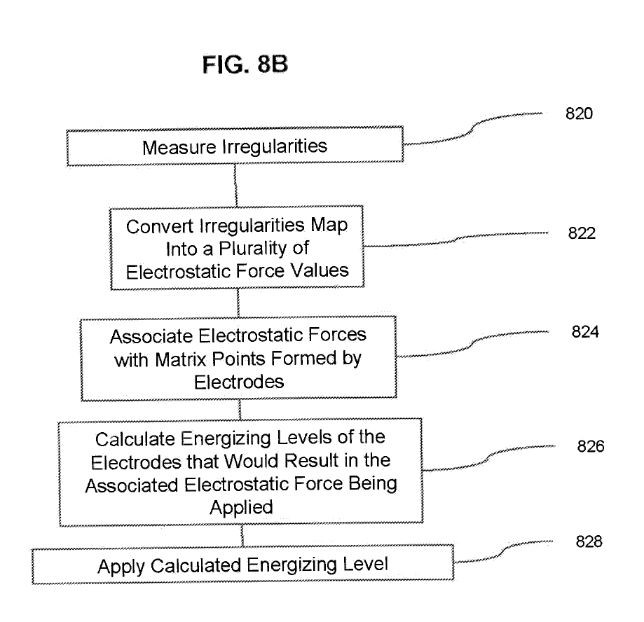

FIG. 8A illustrates another method of the present invention for using the electrostatic chuck with feedback, such that after compensation actuation values are applied to the actuators 351, the image is checked for residual errors that can then be compensated for with additional compensatory actuation of the actuators 351. FIG. 8A comprises the following steps: the patterning device (e.g., a mask) MA (or other clamped object such as a substrate W to be imaged) is clamped to the electrostatic chuck 810, the irregularities are measured 820, the irregularities are compensated for 830, the image is monitored to verify the proper compensation was applied 840, and if any errors remain, then these residual errors are compensated for 850. The lithographic system can measure for irregularities/errors 820 in a number of ways (e.g., the irregularities/errors can be measured using an interferometer system or they can be measured using an image quality evaluation system that takes advantage of the existing imaging system of a lithographic apparatus). To verify proper compensation (at step 840), measurements identical to the initial measurement for irregularities/errors are taken. Application of further compensation for residual errors is in addition to the non-uniform deformation already compensating the image.

In the embodiment shown in FIG. 8B the irregularities/errors are measured instead of receiving the irregularities/errors to be compensated (as shown in FIG. 7B). For example, as with FIGS. 7A and 7B additional steps can be employed. FIG. 8B comprises five more steps between clamping (at step 810) and compensating (at step 830). These five steps are measuring irregularities 820 (shown in FIGS. 8A and 8B), converting the irregularities into a plurality of compensation values 822, associating the compensation values with matrix points formed by actuators 824, calculating actuation levels of the actuators that would result in the associated compensation value being applied 826, and applying the calculated actuation level 828.

In an embodiment of the present invention, the patterning device (e.g., a mask) MA (or other clamped object such as a substrate W to be imaged) to be held in place (i.e., “chucked”) is clamped (at step 810) via a standard uniform non-customized electrostatic field to an image-compensating addressable electrostatic chuck 300 (as shown, for example, in FIG. 3). A measurement of patterning device (e.g., a mask) MA (or other clamped object such as a substrate W to be imaged) irregularities is taken (at step 820) and sent to a dynamic deformation controller (not shown). The controller contains internal logic to convert (at step 822) the measured irregularities (from step 820) into a plurality of compensation values (i.e., the amount of deformation that will be needed to compensate for the surface irregularities). At step 824, the controller associates each of the compensation values with a matrix point. At step 826, an actuation level for each actuator 351 is calculated such that the associated compensation value is applied to the clamped patterning device (e.g., a mask) MA (or other clamped object such as a substrate W to be imaged). At step 828, the calculated actuation level is applied by the controller to the actuators 351 of the electrostatic chuck 300. By applying the actuation level (at step 828) to the actuators 351, step 830 of compensating for the irregularities is accomplished. Applying the addressable actuation levels to the electrostatic chuck 300 can be non-uniform and each of the actuators can be held at a different energizing level. The differing actuation levels create deformations to the patterning device (e.g., a mask) MA (or other clamped object such as a substrate W to be imaged) being chucked. This deformation allows the chuck to reshape the patterning device (e.g., a mask) MA (or other clamped object such as a substrate W to be imaged) being held so as to correct for surface irregularities of the object.

In one example, steps 820 through 828 are repeated in steps 840 and 850 to compensate for any residual errors, not originally measured or created by the first compensation method. The residual compensation is cumulative to the initial compensation. In an embodiment, the compensation using measurement and feedback for residual irregularities/errors is not continuous and considered complete after a user defined number of passes.

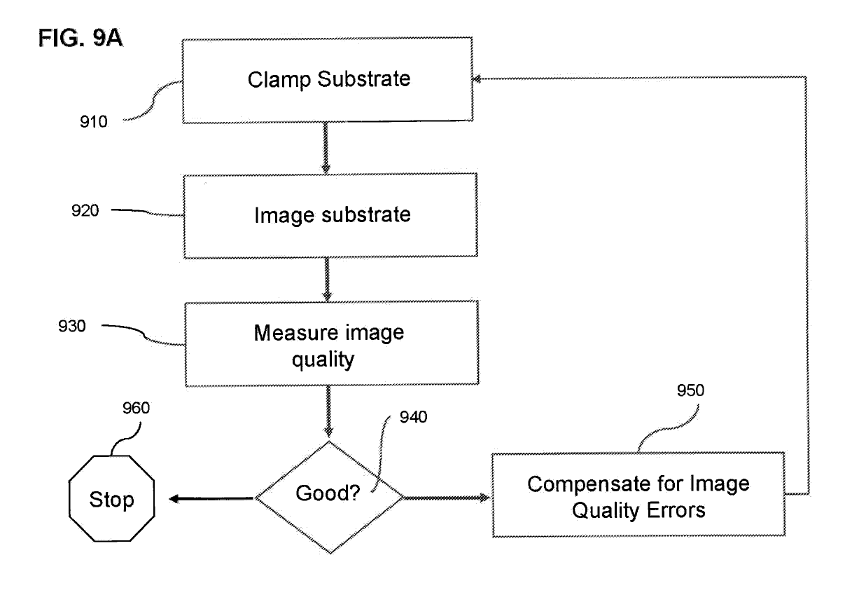

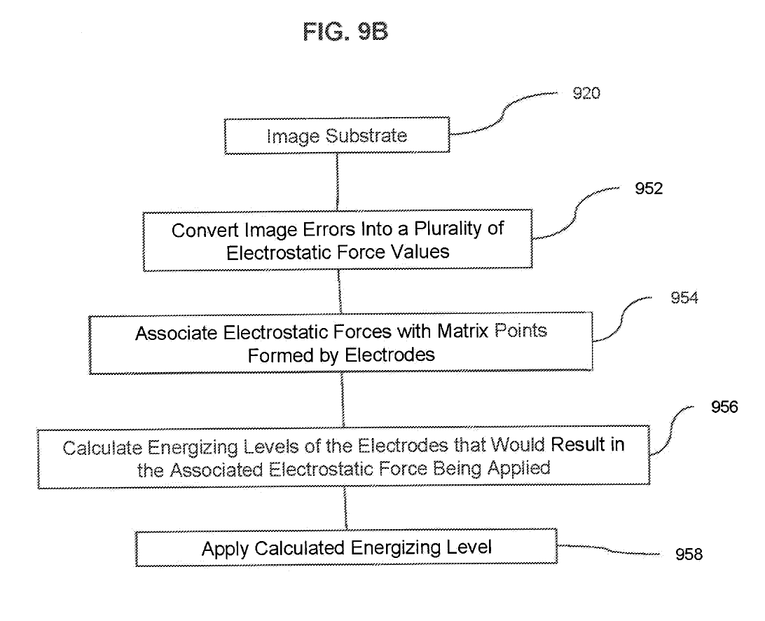

FIG. 9A illustrates a method for using the electrostatic chuck with an image quality feedback image-compensating addressable electrostatic chuck, according to an embodiment of the present invention. In this embodiment, the patterning device (e.g., a mask) MA (or other clamped object such as a substrate W to be imaged) is clamped (step 910) onto the electrostatic chuck with a uniform electrostatic field and all actuators 351 at a neutral position. The patterning device (e.g., a mask MA) (or other clamped object such as a substrate W to be imaged) is imaged (step 920) using an image quality evaluation system. In an embodiment, the image quality evaluation system can use the image components and capabilities of a lithographic system without requiring additional apparatuses. The quality of the image is measured (at step 930). A decision is made about whether the image is good (at step 940). Determining whether an image is “good” is a subjective test, at the discretion of the user. However, there are some objective elements to the test, since the end goal of the present invention is to minimize lithographic device defects and maximize throughput of the lithographic process. These objective elements include non-exclusively: image alignment, image curvature, image focus, image distortion, and astigmatism. If the image is considered good (step 940), the method stops at step 960 because the image quality is acceptable. If however the answer is negative, that the image quality is not good (step 940), then step 950 compensation for image quality is performed, which results in deformations being induced in the object.

FIG. 9B is a detailed view of step 950 compensation for image quality.

In an embodiment illustrated in FIG. 9B, the patterning device (e.g., a mask) MA (or other clamped object such as a substrate W to be imaged) to be held in place (i.e., “chucked”) is clamped (at step 910) via a standard uniform non-customized electrostatic field to an image-compensating addressable electrostatic chuck 300 (as shown, for example, in FIG. 3). A measurement of the image quality (i.e., image alignment, image curvature, image focus, image distortion, astigmatism) is made at step 920 and sent to a dynamic deformation controller (not shown). The controller determines whether the image quality is good enough (step 940). If the image quality is not determined to be good, the controller contains internal logic to convert (step 952) the measured irregularities (step 920) into a plurality of compensation values, (i.e., the amount of deformation that will be needed to compensate for the surface irregularities). At step 954, the controller associates each of the compensation values with a matrix point. At step 956, an actuation level for each actuator 351 is calculated such that the associated compensation value is applied to the clamped patterning device (e.g., a mask) MA (or other clamped object such as a substrate W to be imaged). At step 958, the calculated actuation level is applied by the controller to the actuators 351 of the electrostatic chuck 300. By applying the actuation level (at step 958) to the actuators 351, step 950 of compensating for image quality is accomplished. The differing deformations allow the electrostatic chuck to reshape the patterning device (e.g., a mask) MA (or other clamped object such as a substrate W to be imaged) being held so as to correct for surface irregularities of the patterning device (e.g., a mask) MA (or other clamped object such as a substrate W to be imaged).

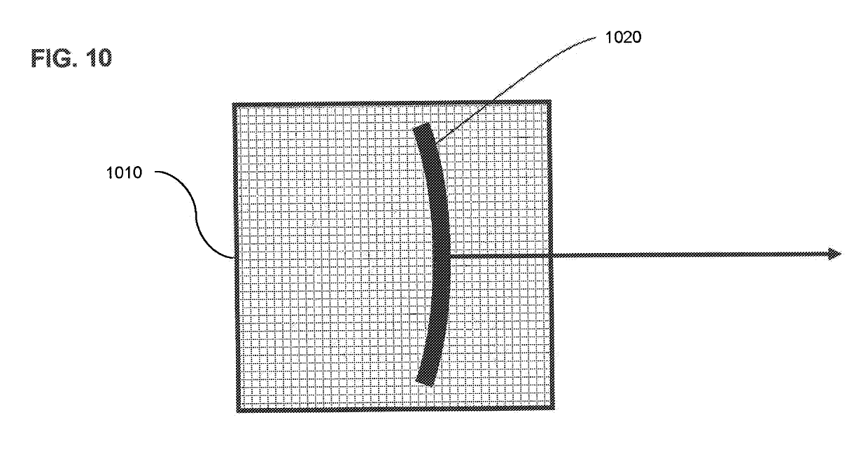

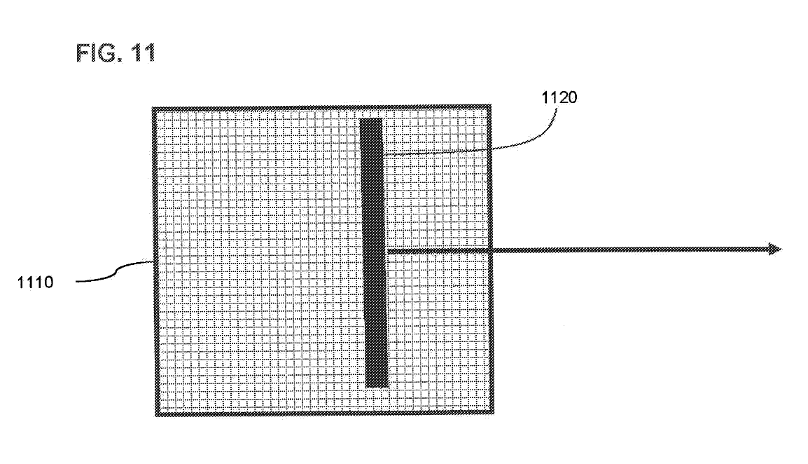

In one example, the image-compensating addressable electrostatic chuck can also correct for scan errors e.g., unflatness errors in the z-direction that are perpendicular to the direction of scan (y). FIGS. 10 and 11 show two separate embodiments of methods of addressing the electrostatic chuck based on the slit illumination of the stage. FIG. 10 shows the addressable electrostatic chuck matrix 1010 and an arc-shaped illumination slit 1020 in the X-direction. Scan errors in the Y-direction can be compensated for at the appropriate time based on the shape of the illumination slit, such as an arc-shaped illumination slit 1020. FIG. 11 shows the addressable electrostatic chuck matrix 1110 that compensates with a linear illumination slit 1120 in the X-direction.

Image-compensating can also be achieved with addressable electrostatic chuck clamping of the target substrate (i.e., wafer), according to an embodiment of the present invention. Residual irregularities/errors in the image quality can be compensated for by applying a non-uniform electrostatic force to the image substrate.

In another embodiment of the present invention, a method of compensating for image errors/patterning device (e.g., a mask) MA/substrate W irregularities by measuring and compensating for a particular type of error/irregularity before measuring and compensating for another type of error/irregularity is performed. The types of image errors/patterning device (e.g., a mask) MA/substrate W irregularities occur with different frequencies within a lithographic system and in order to improve the efficiency of the lithographic system the errors/irregularities should be addressed in similar order.

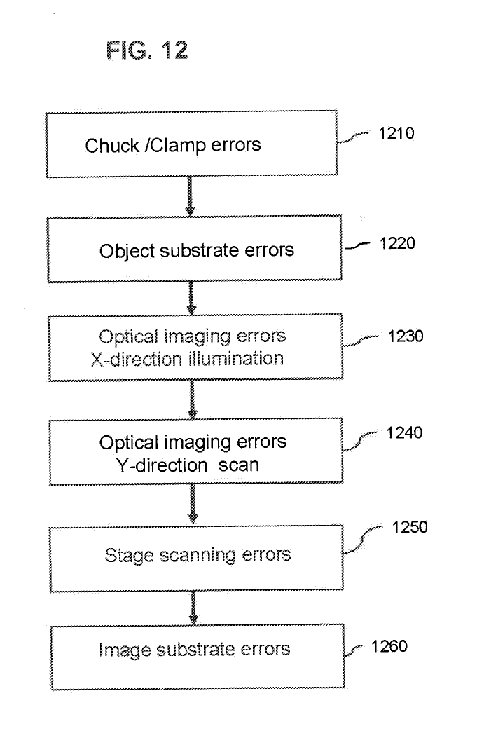

FIG. 12 is a hierarchal chart of the different errors/irregularities and order of implementation of compensation, according to an embodiment of the present invention. The first compensation to be implemented is for chuck/clamp errors 1210. The chuck/clamp component is a permanent piece of the lithographic apparatus and the chuck/clamp's errors/irregularities seldom change (only with temperature extremes and wear and tear). The next compensation to be implemented are the patterning device (e.g., a mask) MA errors 1220 measured at least with each change of patterning device (e.g., a mask) MA. The third compensation to be implemented is optical imaging errors in the X-direction illumination 1230; these errors occur slightly more often than chuck/clamp irregularities and patterning device (e.g., a mask) MA errors due to multiple variables with the lithographic system. The next compensation to be implemented are the optical imaging errors in the Y-direction scan 1240, which similar to the X-direction illumination 1230 occur slightly more often due to multiple variables with the lithographic system. The fifth compensation to be implemented is stage scanning errors 1250 that occur much more often. The scanning errors 1250 are often not deterministic and harder to measure/quantify. The stage scanning errors 1250 that are deterministic are compensated for after the other four compensations have been used to improve the image quality. And lastly, compensation for substrate W errors 1260. The errors are present with each change of the substrate W that occurs frequently. However, the compensation for errors on the substrate W does not have as much effect on the overall image quality as the other types of compensation. Therefore, despite the fact that substrate W errors are the most frequently occurring, the other compensations are usually capable of properly improving the image quality.

In one example, these differing types of compensation are performed piecemeal until the image quality is satisfactory. For example, in some cases only chuck/clamp errors 1210 will need to be compensated for, but in other cases each type of error will need to be compensated in order to achieve acceptable image quality. The compensations are cumulative such that each level will further improve the overall image quality, and once the image quality has achieved an acceptable level, no further compensation is needed.

The descriptions above are intended to be illustrative, not limiting. It will be apparent to one skilled in the art that the invention is also represented by the clauses set out below.
1. A method, comprising:
   utilizing an image quality evaluation system to determine a plurality of image errors affecting an image quality of the imaged object;
   determining a plurality of electrostatic compensation force values based on the plurality of image errors;
   correlating the plurality of electrostatic compensation force values with a plurality of matrix points formed by first and second evenly spaced sets of electrodes disposed in a substrate beneath the support layer of a chuck, the first and second set of electrodes being generally orthogonally oriented to the other set;
   determining an energizing level for each electrode in the first and second set of electrodes corresponding to the associated compensation force value being applied to the object at each of the plurality of matrix points; and
   applying the energizing level to each electrode in the first and second set of electrodes to generate an electrostatic compensation force on the object at each of the plurality of matrix points.
2. The method of clause 1, wherein the plurality of image errors include at least one of image field curvature, image focus quality, image distortion, and astigmatism.
3. The method of clause 1, further comprising:
   (a) determining, with the image quality evaluation system, the image errors affecting the image quality of the imaged object remaining after application of the actuation level to each of the actuators.
4. The method of clause 1, wherein the image quality evaluation occurs apriori to imaging in a lithographic tool.
5. The method of clause 1, wherein the image quality evaluation occurs in-situ in a lithographic tool, utilizing the imaging and image evaluation capabilities of the lithographic tool.
6. The method of clause 1, wherein each of the plurality of actuators forms a plurality of the plurality of matrix points.
7. The method of clause 6, wherein the plurality of the plurality of matrix points are in a line substantially parallel to a scanning motion of the object.
8. The method of clause 6, wherein during the correlating the compensation values of the plurality of the plurality of matrix points for each of the actuators are correlated to a time of a scanning motion and/or a position of the object during a scanning motion relative to an illumination slit.
9. The method of clause 8, wherein the applying takes place at least partly during a scanning motion and during the applying, the actuation level applied to each of the actuators varies according to the compensation value for the time of the scanning motion and/or a position of the object relative to the illumination slit.
10. A method, comprising:
   utilizing an interferometer to determine surface irregularities of an object; determining a plurality of compensation values based on the irregularities;
   correlating the plurality of compensation values with a plurality of matrix points each of which is formed by one of a plurality of actuators disposed between a substrate and a support layer of a chuck;
   determining an actuation level for each actuator corresponding to the associated compensation value being applied to the object at each of the plurality of matrix points;
   applying the actuation level to each of the actuators to deform the support layer in accordance with the compensation values at each matrix point whilst the object is clamped on the support layer; and
   determining, with the interferometer, the surface irregularities of the object remaining after application of the actuation level to each actuator.
10. The method of clause 10, wherein the chucked object has minimal and pre-determined surface irregularities prior to chucking, such that the surface irregularities induced by chucking will be attributed to chuck surface irregularities or spatially non-uniform clamping.

### IV. CONCLUSION

It is to be appreciated that the Detailed Description section, and not the Summary and Abstract sections, is intended to be used to interpret the claims. The Summary and Abstract sections may set forth one or more, but not all, exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been defined for the convenience of the description. Alternate boundaries can be defined so long as the specified functions and relationships thereof are appropriately performed.

The foregoing description of the specific embodiments will so fully reveal the general nature of the invention. Others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the terminology or phraseology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. An electrostatic chuck, comprising:
a substrate;
a support layer configured to support an object;
an electrode layer comprising an electrode and being disposed between the substrate and the support layer and configured to apply an electrostatic attraction force on the object upon energization of the electrode; and
a plurality of actuators configured to deform the support layer.

2. The electrostatic chuck of claim 1, wherein the plurality of actuators are between the electrode layer and the substrate.

3. The electrostatic chuck of claim 1, wherein the plurality of electrodes are on a side of the substrate opposite to the electrode layer.

4. The electrostatic chuck of claim 1, wherein the plurality of actuators are configured to extend and retract in a direction substantially perpendicular to a plane of the surface of the support layer on which the object is supported.

5. The electrostatic chuck of claim 1, wherein the plurality of actuators are arranged in a two dimensional array in a plane substantially parallel to a surface of the support layer on which the object is supported.

6. The electrostatic chuck of claim 1, wherein the plurality of actuators are arranged in a one dimensional array extending in a first direction.

7. The electrostatic chuck of claim 6, wherein the actuators are arranged to deform an elongate portion of the support layer which is elongate in a direction perpendicular to the first direction.

8. The electrostatic chuck of claim 1, wherein the plurality of actuators is a plurality of piezoelectric actuators.

9. The electrostatic chuck of claim 1, further comprising a controller configured to control the plurality of actuators on the basis of a compensation data set.

10. The electrostatic chuck of claim 9, further comprising a compensation data set generator configured to generate the compensation data set from a measure of error to be corrected by the electrostatic chuck.

11. The electrostatic chuck of claim 9, wherein the compensation data set is applied to the actuators dependent upon scan position.

12. The electrostatic chuck of claim 1, wherein the object is a patterning device.

13. The electrostatic chuck of claim 1, wherein the object is a substrate.

14. A lithographic system, comprising:
a reticle support configured to clamp a reticle in a path of a radiation beam so that the reticle produces a patterned beam;
a projection system configured to project the patterned beam onto a target portion of a substrate;
a substrate support configured to support the substrate during a lithographic process; and
an electrostatic chuck coupled to the reticle support, the electrostatic chuck comprising:
a substrate;
a support layer to support an object;
an electrode layer comprising an electrode and being disposed between the substrate and the support layer configured to apply an electrostatic attraction configured to force on the object upon energization of the electrode; and
a plurality of actuators configured to deform the support layer.

15. The lithographic system of claim 14, wherein the plurality of actuators are arranged in a one dimensional array extending in a direction substantially perpendicular to a scanning direction of the reticle support.

16. A method, comprising:
determining surface irregularities of an object;
determining a plurality of compensation values based on the irregularities;
correlating the plurality of compensation values with a plurality of matrix points each of which is formed by one of a plurality of actuators disposed between a substrate and a support layer of a chuck;
determining an actuation level for each actuator corresponding to the associated compensation value being applied to the object at each of the plurality of matrix points; and
applying the actuation level to each of the actuators to deform the support layer in accordance with the compensation values at each matrix point whilst the object is clamped on the support layer.

17. A method, comprising:
utilizing an image quality evaluation system to determine a plurality of image errors affecting an image quality of the imaged object;
determining a plurality of electrostatic compensation force values based on the plurality of image errors;
correlating the plurality of electrostatic compensation force values with a plurality of matrix points formed by first and second evenly spaced sets of electrodes disposed in a substrate beneath the support layer of a chuck, the first and second set of electrodes being generally orthogonally oriented to the other set;
determining an energizing level for each electrode in the first and second set of electrodes corresponding to the associated compensation force value being applied to the object at each of the plurality of matrix points; and
applying the energizing level to each electrode in the first and second set of electrodes to generate an electrostatic compensation force on the object at each of the plurality of matrix points.

18. The method of claim 17, wherein the compensation values are for scanning inaccuracies that generate positional errors perpendicular to a stage, a chuck, an object substrate, or an image substrate.

19. A method, comprising:
utilizing an interferometer to determine surface irregularities of an object;
determining a plurality of compensation values based on the irregularities;
correlating the plurality of compensation values with a plurality of matrix points each of which is formed by one of a plurality of actuators disposed between a substrate and a support layer of a chuck;
determining an actuation level for each actuator corresponding to the associated compensation value being applied to the object at each of the plurality of matrix points;
applying the actuation level to each of the actuators to deform the support layer in accordance with the compensation values at each matrix point whilst the object is clamped on the support layer; and
determining, with the interferometer, the surface irregularities of the object remaining after application of the actuation level to each actuator.

20. The method of claim 19, wherein the surface irregularities, to be determined for compensation do not reside on the chucked object, but rather on a surface onto which the chucked object is imaged.
